(19) United States
(12) Patent Application Publication
(10) Pub. No.: US 2017/0356205 A1
(43) Pub. Date: Dec. 14, 2017

(54) PORTABLE IMMERSIVE AUDIOVISUAL APPARATUS FOR EXHIBITIONS AND METHOD FOR IMMERSIVE, CLOSE PROXIMITY-TO-EXHIBIT EXPERIENCE

(71) Applicant: The Band Perry Live, LLC, Nashville, TN (US)

(72) Inventor: Owen Matthew THOMAS, Indianapolis, IN (US)

(21) Appl. No.: 15/618,938

(22) Filed: Jun. 9, 2017

Related U.S. Application Data
(60) Provisional application No. 62/348,562, filed on Jun. 10, 2016.

(51) Int. Cl. E04H 3/22; E04B 1/343; F21S 8/06; G03B 21/58; H04N 9/31; F21V 21/34; F21W 131/406

(52) U.S. Cl. CPC E04H 3/22; H04N 9/3147; E04B 1/34352; F21V 21/34; F21S 8/06; G03B 21/58; F21W 2131/406

(57) ABSTRACT

A novel, immersive and close-proximity-to-artist concert experience for audiences in a fully panoramic audio-visual setting comprising a customized, portable concert arena defined by a plurality of projection screens at the periphery, displaying pre-programmed video content during a live concert or event, with the artist performing at a central location and the audience located in between the screens and the performing artist, wherein all audio, lighting and video componentry are located outside of the performance area.

### FIELD OF INVENTION

The invention relates to live performance entertainment systems and equipment, particularly audiovisual equipment, to provide an audience with an immersive, enclosed environment that is safely habitable, structurally sound, readily constructible, and easily transportable.

### BACKGROUND OF THE INVENTION

Live musical concert performances have traditionally been two-dimensional, “spectator-based” events. Typically, during a performance musical artists stand on a stage positioned at one end of a room, with an audience sitting or standing on the other side of the room, in front of the artist.

Alternatively, other modern digital entertainment systems like virtual reality (“VR”) or 3D-based entertainment experiences require bulky or awkward additional user hardware (like glasses, goggles, or helmets), do not focus on group experiences, can be cost-prohibitive, and may require users to have certain technical training or specialized knowledge to implement, which tends to make these systems difficult to work with or confusing. Some VR and 3D immersive systems require projection systems that are not readily portable, require special calibration procedures, and must be mounted at specific points adjacent to the screens to work properly. Finally, most VR and 3D immersion systems will not safely accommodate a large audience group, such as two or more hundred people around a centralized performance area.

To keep pace with general public's desire for new and creative visual and audio experiences, what is needed in the art is a novel system of video and audio components assembled and arranged in a manner that allows musical artists to readily present an immersive audio-visual concert experience for their audiences.

### SUMMARY OF THE INVENTION

The apparatus of the current invention creates a novel, immersive and close-proximity-to-artist concert experience for audiences in a fully panoramic audio-visual setting. The current invention comprises a customized, portable concert arena defined by a plurality of projection screens at the periphery, displaying pre-programmed video content during the concert, with the artist performing at a central location and the audience located in between the screens and the performing artist. The current invention further comprises a walled entrance walkway that extends out from the concert area at one corner between two screens such that the immersive experience can only be best viewed from inside the concert area. The current invention further comprises overhead structural support members that join at the center of the performing area and extend outward to the peripheral screens for mounting audio componentry, such as microphones, microphone stands, amplifiers, and speakers, to eliminate the need for placing these components on the central performing area. In one embodiment of the current invention, four projection screens form the periphery of the concert area and the overhead structural support members form a cross-shape centered over the performing area and vertically supported at each point of the square formed by the projection screens. In this embodiment, two of the projection screens are spaced apart slightly to accommodate the entrance walkway extending outward from the performing area. In this embodiment, a third overhead structural support member spans the opening of the covered walkway on the side closest to the performing area and is vertically supported at either side of the opening of the covered walkway into the performing area. Opaque panels hung inside the walls of the entrance walkway and at the entrance to the performing area combined with the peripheral screens allow the artist's audio-visual media to be best experienced only from within the audience area around the central performing area.

In one embodiment, the overhead structural support members and their vertical support columns are comprised of standard aluminum stage trussing. In this embodiment, the amplified sounds of the performers vocals and/or instruments are projected down onto the audience by a surround-sound array of speakers mounted on the overhead trusses and/or speakers mounted at the floor-level at each of the vertical truss supports. By distributing the amplified sound to the audience from multiple points around the performance area, the soundscape experience is significantly enhanced.

In another embodiment, the entrance walkway is further comprised of a two-way pedestrian traffic design, which would allow continual entry and exit movement for audience members.

In still another embodiment, a scalable composite pixel matte system is used to allow image media to be readily imported into film editing software that supports large-scale files that can be projected on the room's walls during performances or exhibitions. All operational audio, projection, power, and rigging components are positioned outside the performance area to provide the most amount of room for audience and performers. Similarly, all microphone and instrument components used by performers can be wireless and supported within the overhead trusses to provide an unencumbered performance space.

### DESCRIPTION OF FIGURES

FIG. 1 is a top-side perspective view of an embodiment of a performance room.

FIG. 2 is a top-side perspective view of an embodiment of an apparatus with a lighting rig over a performance room.

FIG. 3 is a top-down plan view of one embodiment of the invention.

FIG. 4 is a top-down plan view of one embodiment of the invention as might be constructed in a commercial building.

FIG. 5 is a top-down plan view of one embodiment of the current invention with dimensions given.

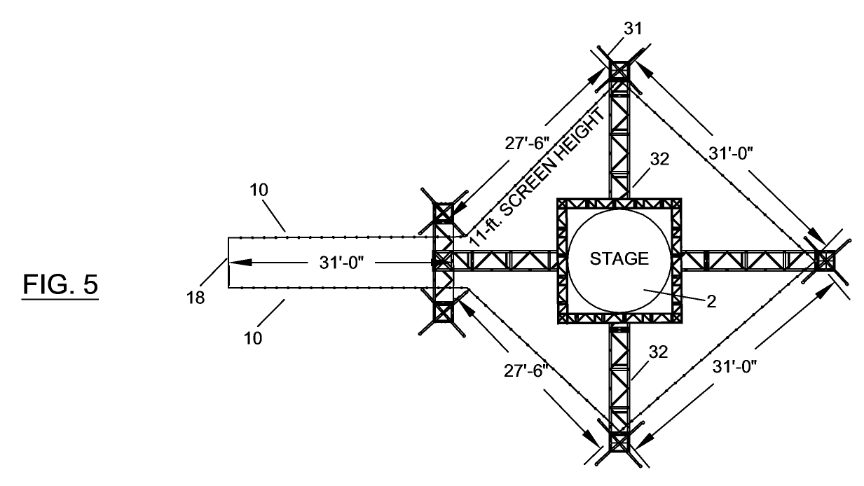

FIG. 6 shows a flow chart of the steps in processing the visual content for projection on the viewing screens for one embodiment of the current invention.

### I. VIEWING STRUCTURE

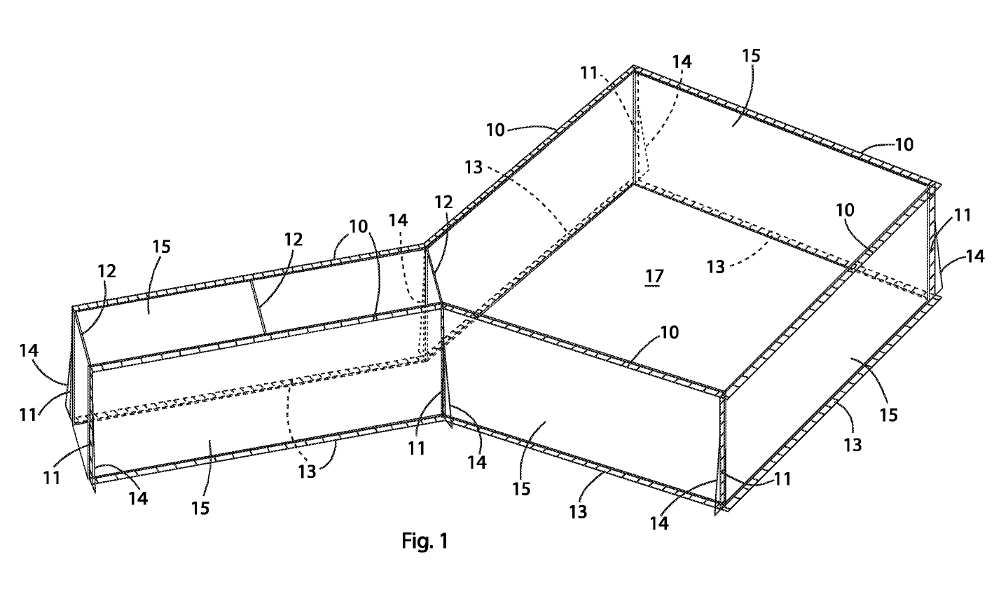

In reference to FIG. 1, an embodiment of the current invention is shown comprising a 4-wall panel system. The video projection walls 15 are arranged to form a square-shaped performance area 17. Where each video wall adjoins, a vertical truss member 11 is placed that serves as a support member for the sides of the video panels. In one embodiment, horizontal truss members 10 connect to the top end each of the four vertical truss members to form an elevated support truss system along the top sides of the video projection walls. In one and embodiment, the video projection walls are attached to the vertical and elevated truss members using common snap-locks, which allows them to be quickly set in place and quickly taken down, for example, if a sudden need to evacuate the audience members from the enclosed soundstage area due to an emergency. In one embodiment, there is no trussing inside the performance room to make the performance room safe when filled with spectators.

In continued reference to FIG. 1, additional vertical truss members 11 and horizontal truss members 10 define a rectangular area comprising the entrance walkway 18. In one embodiment, the entrance walkway 18 is assembled to the truss members and sized similarly as the video projection walls 15. In one embodiment, the side walls of the entrance walkway 18 are pre-printed, fixed display panels whereas the 4 video projection panels are the only panels provided with dynamic videography projectors. However, in another embodiment, the entrance walkway panels are video projection panels and can also be projected with dynamic videography.

In continued reference to FIG. 1, in another embodiment, additional bottom truss members 13 are connected to the bottom ends of the vertical truss members 11 in a pattern matching the upper horizontal truss members 10. At the points where all of the horizontal and vertical truss members connect, any of the number of ways trusses can be attached to form a rigid, interconnected 3-D truss structure are incorporated herein by reference as one skilled in the art would know. In one embodiment, the vertical truss members 11 are further supported in their vertical orientation by truss support braces 14 to provide additional structural support to the overall systems of trusses. In still another embodiment, the truss support braces 14 can be further stabilized to the floor of the area using sandbags, weights or fastened directly to the ground. In the embodiment of FIG. 1, a plurality of cross support braces 12 can be installed across the upper support trusses of the entrance walkway to further enhance the stability and sturdiness of the overall 3-D truss structure.

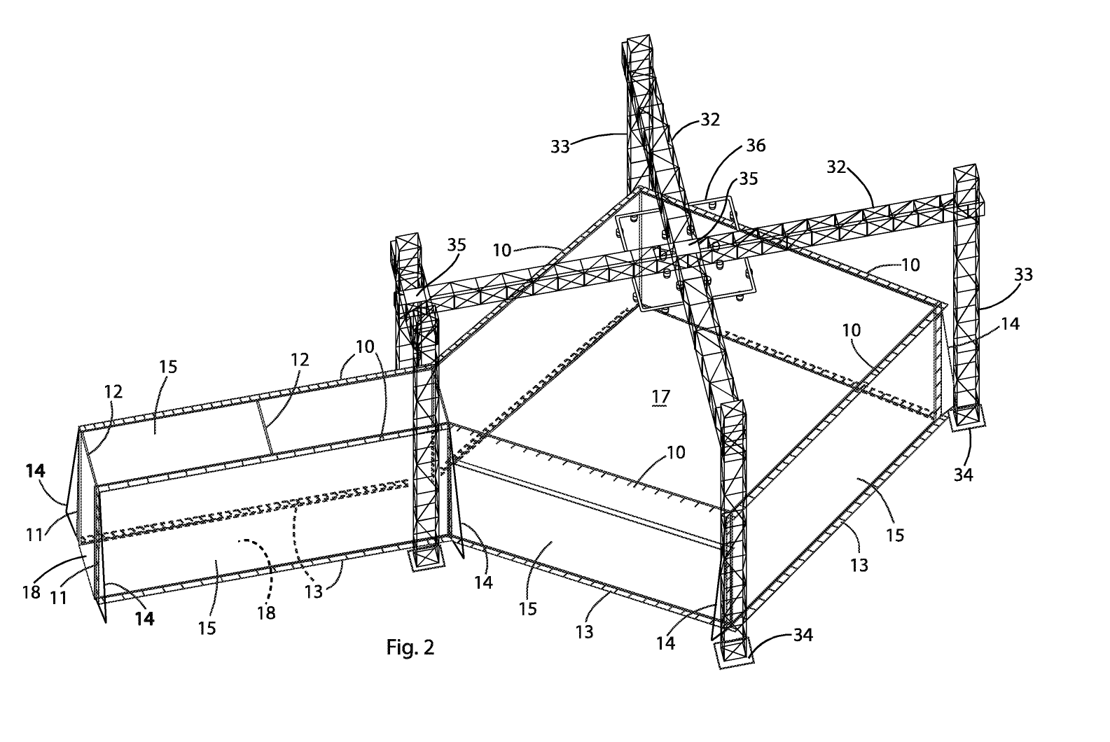

In one embodiment, the video projection walls 15 are comprised of 2-Vu double-sided projection material or any other material designed for displaying rear projection video. In the embodiment of FIGS. 1 and 2, the area above the performance area 17 and the upper horizontal trusses 10 is open to the larger space the visual-audio immersion system is constructed within so that, for example, the immersion system itself does not require dedicated ventilation or HVAC air exchange equipment when the audience and performers are present. An elevated performing stage for the artists is located centrally within the performance area 17 while the audience occupies the area between the central stage and the video projection walls. Typically, while the artists perform, the dynamic video media is projected onto the video wall panels in synchronization with the artists' performance in a newly creative manner that when combined with a distributed audio component creates the visual-audio immersion system that is the current invention.

In reference to FIG. 2, which shows the 3-D truss structure of FIG. 1, a second, larger hoisting truss system is erected over the performance area 17 and is comprised of vertical hoisting trusts 33 placed adjacent to the vertical support trusses 14, and two horizontal support trusses 32 forming a crossing pattern centered over the performance area 17. Hoisting trusses are typically standard stage truss members that are fitted on each end with a motorized or cable wench element that causes the horizontal truss members to move up or down on the framing of the vertical truss members while maintaining structural rigidity of all interconnected truss members. The lifting power of these hoists are variable and are typically sized based on the weight load of the horizontal truss members themselves in addition to the weight of lighting and other audio componentry and cabling that might be attached to the horizontal truss members at the discretion of the stage designer and/or artists' preferences. In one embodiment, standard steel box vertical trusses are affixed at the bottom to base plates 34 or Genie lifts to maximize strength and safety. One ton hoists are connected at the ends of the horizontal truss members 32 using corner truss connectors. In the embodiment of FIG. 2, the horizontal trusses 32 extend diagonally across the performance room 17 to form a cross centered over the performing stage and support lighting and audio components that are hung from the underside of the trusses 32. An optional speed rail 36 is supported by the trusses allowing for connection of standard pre-designed, pre-wired lighting systems to the horizontal truss members 32. However, lighting componentry could be attached directly to the underside of the horizontal trusses 32. Truss connector blocks 35 can be used to interconnect shorter truss sections to provide a single truss member that meets the required lengths depending on the desired overall size of the visual-audio immersion systems constructed. Where the horizontal truss member 32 meets the opening of the entrance walkway 18, a third short horizontal truss member spans the opening of the entrance walkway 18 to reach the vertical truss members placed on either side of the opening into the performance area 17.

It would be obvious to one skilled in the art of stage truss design and construction that various combinations of truss dimensions, number of trusses used to span the performance area 17, and truss interconnecting means can be selected to work for the weight loads anticipated by any combination of lighting and audio componentry supported from the horizontal 32 and vertical truss members 33. Therefore, any number of different truss configurations can be envisioned to carry out the functions of the current invention based upon the discretion of the stage designer and/or the performers. In one embodiment of FIG. 2, the vertical lighting trusses 33 are comprised of six 20.5″ box vertical lighting trusses and the two horizontal trusses are of similar truss type that are joined to span a performance area width of approximately 44 feet. In another embodiment, only two vertical truss members 33 and one horizontal truss member 32 could be used if the combination of truss load capacity and the number of lights and audio componentry required to be supported and the span length are safely rigid and adequate for this combination.

In one embodiment, the lights mounted to the horizontal trusses 32 and/or the optional lighting speed rail 36 create the perception to the performers and audience members that the performance room 17 is enclosed by a ceiling. Typically, an audience member standing in the performance room 17 cannot see up out of the performance room 17 beyond the lights.

In continued reference to FIG. 2, the base plates 34 for the vertical truss members 33 are typically square base plates. In one embodiment, the steel base plates are 36″ square, which is adequate to provide support for the entire lighting and audio rigging system.

FIGS. 1 and 2 depict a four-walled immersion system with a single entrance walkway 18 extending away from one corner of the room shape formed. However, in other embodiments, 5, 6, or more projection walls could be installed and more than one entrance walkway could extend away from the center performance area using the general concepts described herein. Multiple immersion systems could also be interconnected through their entrance walkways to form a plurality of individual visual-audio performances each with their own immersion experience and Audience members able to freely move throughout the interconnected performances. In still other embodiments, the entrance walkway 18 may be omitted, for example, to accommodate a smaller indoor space available.

### II. PROJECTION

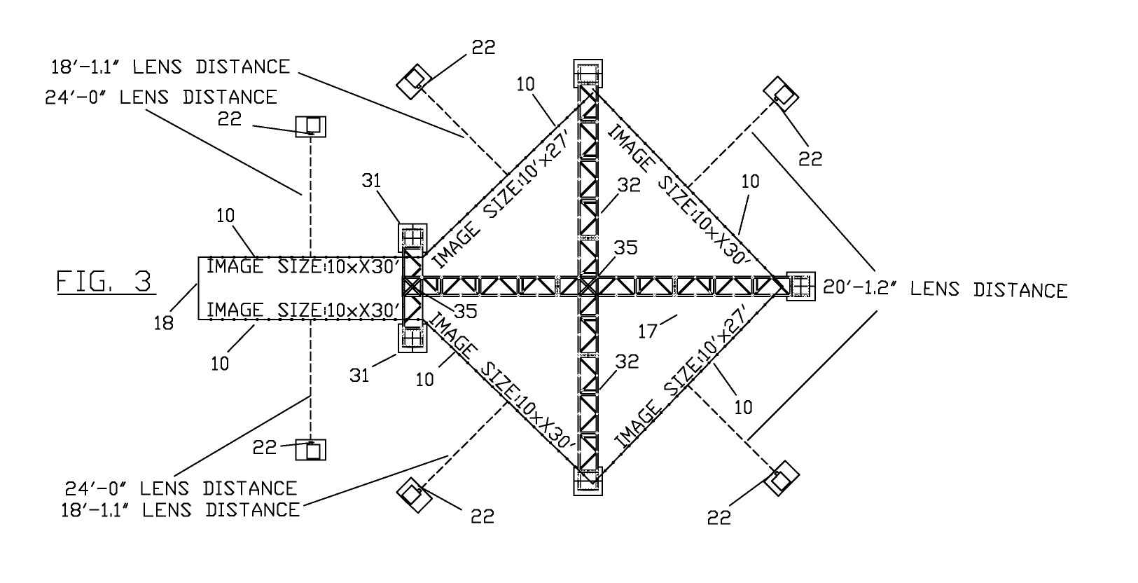

In reference to FIG. 3, an embodiment of the current invention is shown comprising two 10 ft.×30 ft. and two 10 ft.×27 ft. video projection screens 10 placed in a substantially square configuration and forming the performance area 17 and two 10 ft.×30 ft. video projection screens 10 forming the walls of the entrance walkway 18. In one embodiment, the two performance area screens that are adjacent to the entrance walkway screens are slightly shorter in length than the screens opposite the entrance. The performance screens may not be exactly 90 degrees relative to each other because of the width chosen for entrance walkway and the projector locations can be altered slightly to maintain a consistent aspect ratio and video focus. For the embodiment of FIG. 3, the entrance walkway screen projectors are set at a 24 ft. projector distance at a lens focus setting of 0.8. The two 10 ft.×27 ft. performance area screens adjacent to the entrance walkway screens have a projector spacing of approximately 18.1 ft. and a lens focus setting of 0.67. The two other 10 ft.×30 ft. performance area screens have a projector spacing of approximately 20.1 ft. and a lens focus setting of 0.67. One skilled in the art of video projection will understand that to maintain consistent aspect ratio and focus at the point of image view is determinant on the combination of spacing, screen dimensions and lens settings. In some cases, the available spacing distance between the projector and the video screen may be limited by the available spacing of the larger interior environment within which the immersion systems is constructed. Generally, as part of the normal tuning of the projectors, all geometrical limitations, equipment manufacturer's specifications, and video media content must be considered and the projectors must be adjusted as needed to provide a consistent and optimal viewing perspective of all screens to the audience.

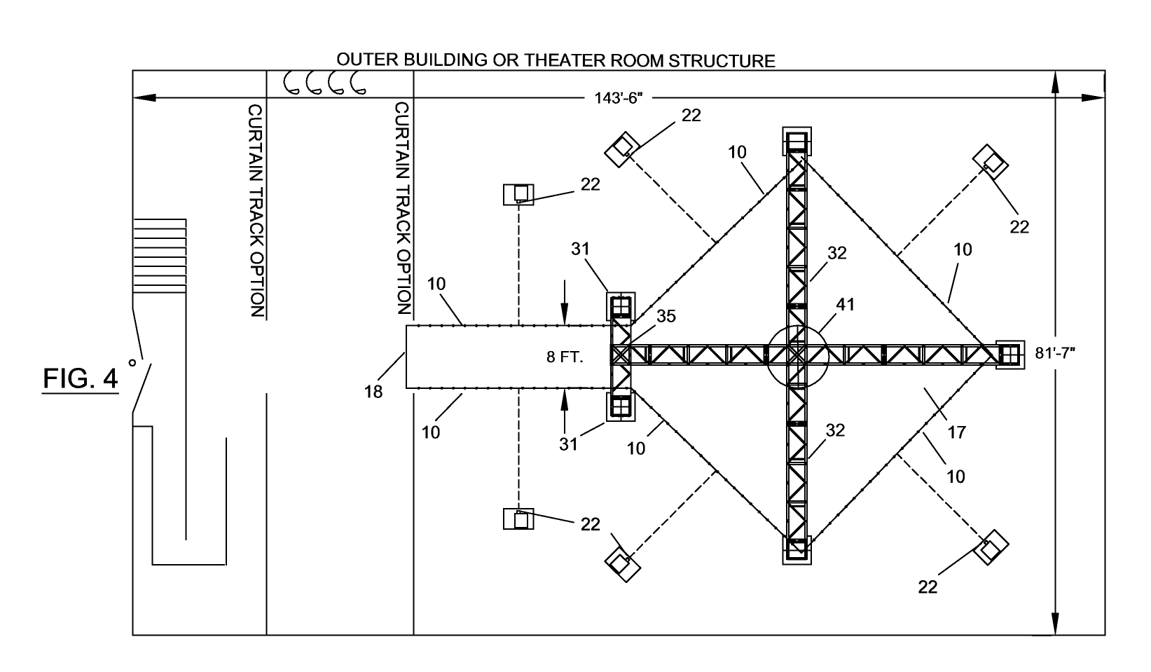

In reference to FIG. 4, the embodiment of FIG. 3 is shown as part of a larger plan view showing an embodiment of the current invention constructed within a larger indoor building space. In this embodiment, the width of the entrance walkway 18 was selected to be approximately 8 ft. and a circular performance stage 19 is centrally located within the performance area 17. Two optional staging rooms outside the entrance walkway 18 could be formed by known materials to further isolate the equipment, visual media and sound used in the immersion system from patrons or incoming audience members within the larger indoor building space.

In reference to the embodiments of FIGS. 3 and 4, the primary equipment items that form the media content transmission backbone of the visual-audio immersion system are comprised of:

6 rear projectors of 20,000 lumens or more with adjustable lenses 21, 22,
1 video signal input/output matrix for distributing video content to the projectors,
1 or more render-engine media servers for distributing video content to the distribution matrix,
At least 1 high-bandwidth digital/analog stereo audio interface module,
One or more microphone preamplifiers,
At least 1 computer with audio media input/output capability,
1 or more computer monitors, and
At least 1 gigabit Ethernet switch.

One skilled in the art of the use of such equipment items will understand how they are interconnected and any additional cabling or componentry required to interconnect these items. Such a person will also know that any number of a variety of screens and screen arrangements used within the immersion system can be envisioned and that the media content transmission backbone componentry must be adjusted accordingly. In the preferred embodiment, all of the media transmission equipment and interconnected cabling and componentry are generally hidden from audience members by the combination of the arrangement of the various video screens, the height selected for the video screens, and optionally other stage materials such as hanging curtains or temporary portable isolation screens. In one embodiment, the render-engine media servers are pre-programmed before the artists' performance by designing a combination of a plurality video-layers and graphics-layers into a time sequence that can be synchronized to the artists' performance, which greatly enhances the immersion experience visualized by the audience members. With such an invention, the artists and their visual-audio collaborators have a new tool to create and express their performance craft. For audience members, this enhanced creative tool in the hand of the artists, is transformative as to how the artist-audience connection is experienced.

In still another embodiment, an external audio signal, which can be either collected from microphones placed discretely around the performance stage for vocals or acoustic or amplified instruments, or pre-recorded onto a computer and played at choreographed times during the performance, can also be sent to the render-engine media server(s), which audio signal is then distributed through an exterior amplified speaker system. In one embodiment, the external speakers are placed in the overhead truss members or outside the structure (behind the rear projection video screens) to enhance the distribution of the audio signal to the audience and to increase the available space for the artists and audience members.

In other embodiments, additional or alternate configurations of projectors can be used to project split screen video content or other visual effects on the plurality of video screens. In one embodiment, the projectors are placed behind the video screens (i.e., rear-projecting) and outside of the performance area 17 so that the maximum room is available for audience members and so the audience will not obstruct the video projection.

### III. LIGHTING

In continued reference to the embodiment of FIGS. 1-3, the area above the video screens is generally open to a larger outer room. Consequently, structural aspects of the larger exterior room may be viewed by audience members within the performance area 17, which may detract from the artists' desired visual immersion experience. However, since the need for air exchange between performance area 17 and the larger outer room will be necessary in most instances for the personal comforts of the audience members and artists, the artists can minimize the unwanted visual aspects of the outer room by incorporating a lighting system over the performance area 17. Generally, because the lighting system luminosity is greater than the luminosity of the outer room within which the immersion system is constructed, an impression of a ceiling is created to the performance area without the associated confinement feeling that an actual ceiling might create to certain audience members or the performing artists. In instances where the structure of the outer room might be appealing to the artists, various lights and/or lighting effects may also be created by directing some light and projection effects componentry away from the performance area outward into the larger room.

### IV. CONTENT PROCESSING

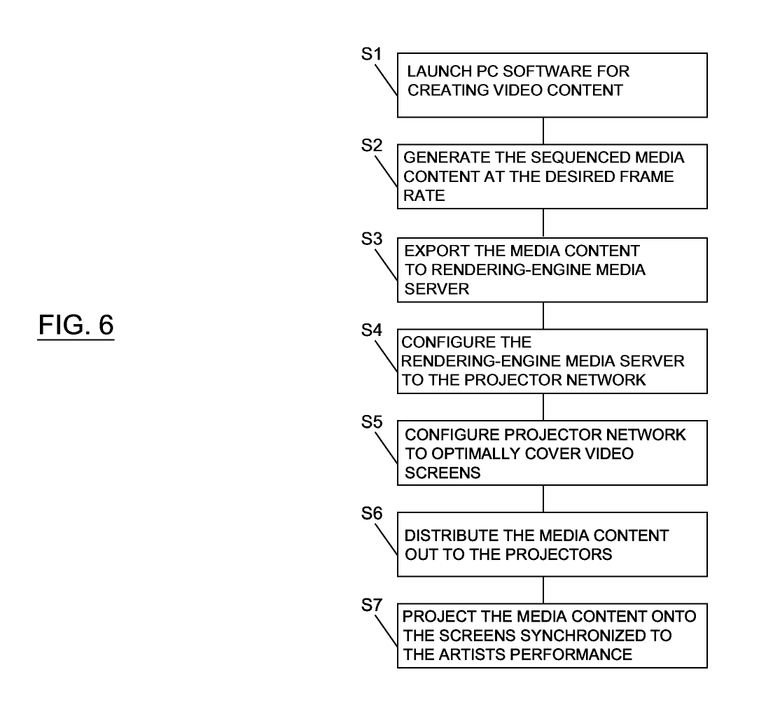

In reference to FIG. 6, the visual content projected onto each screen can be synchronized or projected independently from the visual content shown on the other screens. The audio can also be synchronized with one or more of the screens or be independent from the visual content being projected. In one embodiment, this synchronization is programmed into the timecode of the render-engine media server. The visual content processing steps required to use this system include the following:

S1. Launching a computer-based software capable of creating and editing video content.

S2. Generating the sequenced media content at the desired frame rate (e.g., 10-90 frames per second) by importing custom or licensed video content into the software platform.

S3. Exporting the generated media content to one or more rendering-engine media servers via a compatible codec protocol.

S4. Configuring the rendering-engine media servers to the connected projector network and optionally apply any special visual effects desired to the generated media content.

S5. Configuring the projectors to optimally display onto the plurality of video screens that comprise the performance area and the optional entrance walkway screens.

S6. Distributing the generated media content out to the network of projectors connected to the rendering-engine media servers.

S7. Projecting the generated media content on to screens in a manner that is synchronized with the performance in a manner that enhances the artists' visual-audio expression.

In the embodiment of FIG. 6, the first and second steps in generating and displaying the visual content to be projected on to the video screens involves using a computer-based program, such as Adobe's Premiere Suite, to sequence together the images desired to be displayed by the artists during their performance. This step is where the creativity of the artist and their collaborators is mostly expressed and often is most critical to the immersive experience the artist is seeking to create for audience members. Depending on the technical capabilities of the software program, a variety of digital video file formats can be incorporated at this step and compiled into a common video output format. In one embodiment, the viewable pixel area of an individual screen is configured to be 11,136 horizontal pixels by 640 vertical pixels. The pixel aspect ratio is configured to “square” pixels (value=1.0) with a progressive scan option selected. Maximum bit depth and maximum render quality options are also configurable parameters within the software. In one embodiment, the media is generated by importing a matte system image into the software. When configuring a multiple screen layout design, an edited matte system image can overlay on top of any other imported visual content and allow individual or multiple screen edits in the multiple screen layout.

One skilled in the art of digital video content creation and distribution would know that the selection of resolution and signal transmission bandwidth and digital data communication codecs must be selected such that the equipment chosen to carry out these steps will require some balance between capacity and cost for any given performance situation. Time and portability constraints may also be factors to consider for those content creators and transmission signal technicians who set-up any embodiment of the current invention. In one embodiment, the pixel resolution of all the screens is chosen to be 3,648 horizontal pixels×640 vertical pixels, which is a good balance between data processing speeds, visual graphic detail, and overall video equipment costs.

Steps 3 and 4 involve exporting the generated digital media content to and configuring one or more rendering-engine media servers. The “show” timecode, which is the timing sequence that will synchronize all of the video content with the audio content and artists' performance, are programmed onto this timecode. For most types of rendering-engine media servers, computer-software is also utilized to configure and control the operation of the media servers when connected to the network of projectors chosen. In one embodiment, three edited video media files are compiled and loaded into a rendering-engine media server on a common timecode. Each file can be the same length and played simultaneously with the other two files or staggered.

Step 5 involves configuring the network of projectors to optimally display the content onto the video screens. In one embodiment, this involves placing the projectors at a distance away from the outward surface of the video screen and making adjustments to the lenses to account for spacing distance, angle of projection, and visual focusing.

Steps 6 and 7 involve the conversion, distribution and display of the digital video content into the actual images the audience members see when practicing the invention.

### V. AUDIO CONTENT PROCESSING

In one embodiment of the current invention, the audio componentry for use in the visual-audio immersion system is comprised of a plurality of powered speaker elements (with frames compatible with truss mounting methods), a live-sound mixing and processing console, a signal distribution amplifier, one or more audio feeds from sound sources generated within the performance area, and one or more audio sends from the console to the plurality of speakers. In one embodiment, the plurality of speakers are arranged around the outside of the performance room 17, and the audio content can be projected either synchronized with or independent from the visual content being projected on the viewing screens. In still another embodiment, the one or more audio feeds into the console can be live or prerecorded tracks or a combination of the two. Once the audio sources are properly mixed and converted to digital signals, they can be synchronized with the video content by integrating the digitized audio into the same timecode that the rendering-engine media server plays the visual media. The synchronized audio signal is exported to the sound amplification system while the video signal is distributed to the various video screens.

In one embodiment, the apparatus is configurable to comply with municipal fire codes, OSHA regulations and other state and local regulations. Additionally, all microphone and instrument components used by performers in the apparatus can be wireless or hung from the lighting trusses to create an entirely clean floor space with no intrusions or tripping hazards; allowing full compliance with the Americans with Disabilities Act, rules, and regulations (ADA) and easy access by wheelchair and handicapped guests. In such an embodiment, all audio speakers are positioned and project sound from the upper corners of the performance room, area or space and from the floor outside the performance room and the entry corridor of the apparatus is capable of bearing two-way traffic at any moment, creating a fluid and safe flow of continual entry and exit movement for audiences. Additionally, because the viewing screens are attached by snaps or other detachable connectors, they can easily be pulled away from their frames to allow additional exit points if needed. In such an embodiment, the apparatus has no ceiling allowing for adequate ventilation for up 200 or more viewers inside the apparatus while complying with municipal fire codes, OSHA regulations and other state and local regulations. In such an embodiment, the apparatus is entirely ground-supported in its setup, with no need for any kind of ceiling or wall rigging in a building or venue as is required for most other types of live, indoor performance. The apparatus can also take advantage of existing indoor sprinkler systems to comply with fire safety and OSHA standards. All of the apparatus' operational audio, projection, power, and rigging components can be positioned outside the performance area, again contributing to a clean, safe floor space for spectators inside the performance room. In one embodiment, the method is used to create an entertainment experience for spectators without any trussing, lighting, or audiovisual equipment inside the performance room. The method is also used to provide an entertainment experience that is compliant with ADA requirements and local fire codes for indoor public performances. Setup and teardown of the apparatus can be done quickly with a capable group of technicians. All of the components are designed to be disassembled and folded to allow the apparatus to be transported using standard sized touring vehicles.

Beyond the musical performance usage of the apparatus, the structure can also be used for film or retail premieres, special events, exhibits, interactive sports, corporate, or education presentations, and other types of public exhibitions.

1. A portable exhibit apparatus comprising:
A performance room, further comprising:
at least four screen frames forming walls to the performance room, each screen frame further comprising, a top horizontal truss and a bottom horizontal truss, the horizontal trusses of the screen frames being connected by vertical trusses, and each vertical truss connected to a support brace, and
at least four viewing screens, each viewing screen detachably connected to a screen frame;
A lighting rig above the performance room, the lighting rig further comprising:
at least two vertical lighting trusses,
at least one horizontal lighting truss having two ends,
the at least two vertical lighting trusses each being connected to one end of the at least one horizontal lighting truss,
the at least one horizontal lighting truss being at least partially suspended above the performance room, and
lighting components suspended from the lighting rig above the performance room;
At least two video projectors positioned outside the performance room and configured to project visual content on the at least four viewing screens; and
At least two speakers positioned outside the performance room and configured to project sound into the performance room;
Wherein the apparatus is a portable performance room capable of accommodating more than fifty spectators in close proximity to an exhibit or performance.

2. A portable exhibit apparatus comprising:
A performance room, further comprising:
at least four screen frames forming walls to the performance room, each screen frame further comprising, a top horizontal truss and a bottom horizontal truss, the horizontal trusses of the screen frames being connected by vertical trusses, and each vertical truss connected to a support brace, and
at least four viewing screens, each viewing screen detachably connected to a screen frame;
Wherein the apparatus is a portable performance room capable of accommodating more than fifty spectators in close proximity to an exhibit or performance.

3. The apparatus of claim 2, further comprising:
A lighting rig above the performance room, the lighting rig further comprising:
At least two vertical lighting trusses,
At least one horizontal lighting truss having two ends,
The at least two vertical lighting trusses each being connected to one end of the at least one horizontal lighting truss,
The at least one horizontal lighting truss being at least partially suspended above the performance room, and
Lighting components suspended from the lighting rig above the performance room.

4. The apparatus of claim 2, further comprising:
At least two video projectors positioned outside the performance room and configured to project visual content on the at least four viewing screens; and
At least two speakers positioned outside the performance room and configured to project sound into the performance room.

5. The apparatus of claim 4, further comprising the projectors connected in a network, and a rendering-engine media server connected to the projector network.

6. The apparatus of claim 4, further comprising a walkway entrance to the performance room comprising at least two additional viewing screens and at least two additional video projectors positioned outside the walkway entrance and configured to project visual content on the at least two additional viewing screens.

7. The apparatus of claim 2, further comprising snap-lock connectors to connect the at least four viewing screens to the at least four screen frames, wherein the viewing screens can be quickly removed allowing an audience member to evacuate due to an emergency.

8. The apparatus of claim 2, further comprising at least six viewing screens and six screen frames.

9. The apparatus of claim 4, further comprising all trusses, rigs, speakers, and projectors located outside the performance room.

10. A method for an immersive, close proximity-to-exhibit experience, the method comprising:
Projecting visual content from at least two video projectors positioned outside a performance room;
Configuring the video projectors to project visual content on at least four rear projection viewing screens, the at least four viewing screens attached to screen frames, the screen frames and viewing screens forming walls to the performance room, and each screen frame further comprising: a top horizontal truss and a bottom horizontal truss, the top and bottom horizontal trusses of the screen frames being connected by vertical trusses, with each vertical truss connected to a support brace, and each of the four screen frames having a detachably connected viewing screen;
Projecting sound into the performance room from at least two speakers positioned outside the performance room; and
Shining lights down on the performance room from a lighting rig, the lighting rig further comprising:
at least two vertical lighting trusses,
at least one horizontal lighting truss having two ends,
the at least one horizontal lighting truss being at least partially suspended above the performance room, and
lighting components suspended from the lighting rig above the performance room.

11. The method of claim 10, wherein there is no trussing, lighting, or audiovisual equipment inside the performance room, and the performance room is compliant with ADA requirements and local fire codes for indoor public performances.

12. A method for an immersive, close proximity-to-exhibit experience, the method comprising:
Projecting visual content from at least two video projectors positioned outside a performance room;
Configuring the video projectors to project visual content on at least four rear projection viewing screens, the at least four viewing screens attached to screen frames, the screen frames and viewing screens forming walls to the performance room, and each screen frame further comprising:
a top horizontal truss and a bottom horizontal truss, the top and bottom horizontal trusses of the screen frames being connected by vertical trusses, with each vertical truss connected to a support brace, and each of the four screen frames having a detachably connected viewing screen;
Projecting sound into the performance room from at least two speakers positioned outside the performance room; and
Shining lights down on the performance room, wherein lighting components are suspended from a lighting rig.

13. The method of claim 12, wherein there is no trussing, lighting, or audiovisual equipment inside the performance room, and the performance room is compliant with ADA requirements and local fire codes for indoor public performances.

14. The method of claim 12, wherein the lighting rig further comprises:
At least two vertical lighting trusses,
At least one horizontal lighting truss having two ends,
The at least one horizontal lighting truss being at least partially suspended above the performance room, and
Lighting components suspended from the lighting rig above the performance room.
